(19) United States
(12) Patent Application Publication
(10) Pub. No.: US 2007/0102949 A1
(43) Pub. Date: May 10, 2007

(54) Toolbox rollback kit for pickup trucks

(76) Inventor: Norman Ray Andrews, Wilson, NY (US)

Correspondence Address: NORMAN R. ANDREWS, 2284 BEEBE RD., WILSON, NY, 14172, US

(21) Appl. No.: 11/581,723

(22) Filed: Oct. 16, 2006

Related U.S. Application Data
(60) Provisional application No. 60/733,919, filed on Nov. 4, 2005.

(51) Int. Cl. B60R 9/06

(52) U.S. Cl. 296/37.6

(57) ABSTRACT

A toolbox rollback kit for pickup trucks which includes a pair of carriage units (2) adapted to be connected under the ends of a transverse mounted toolbox (17) with suitable rollers (2) carried by the frame for supporting the toolbox (17) and permitting the same to be transferred along the sides of a truck body (15) in suitable channels (1) mounted on the upper edges of the truck body (15) sides with means for stabilizing roller (4) movement of the toolbox (17) and means for locking the toolbox (17) in different positions along the length of the truck body (15) in accordance with the desired functional position of the toolbox (17) And means for securing the toolbox (17) against unauthorized removal or theft.

### CROSS-REFERENCE TO RELATED APPLICATIONS

This application claims the benefit of provisional patent application Ser. No. 60/733,919, filed 2005 Nov. 4 by the present inventor.

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to a moveable support system for mounting a crossover toolbox on the top edges of the sides of a pick-up truck.

2. Prior Art

For many years toolboxes have been mounted across the front of a pick-up truck body. The positioning of the toolbox at the front end of the truck body makes access to the box relatively difficult. A number of different mechanisms have been developed for permitting the box to be moved to the back of the truck body when in use and otherwise stored in the front of the body.

Some of these devices include rail systems for slidably mounting tool boxes between the side walls of the bed. Not only are these devices complicated in their structure and difficult to assemble and operate, but they are not easily adapted to fit truck beds of different shapes and sizes. Such devices are embodied in the following U.S. patents:

| U.S. PAT. NO. | ISSUE DATE | PATENTEE |
|---|---|---|
| 2,784,027 | Mar. 5, 1957 | Temp |
| 3,471,045 | Oct. 7, 1967 | Panciocco |
| 3,826,529 | Jul. 30, 1974 | Wood |
| 4,488,669 | Dec. 18, 1984 | Waters |
| 4,681,360 | Jul. 21, 1987 | Peters et al |
| 4,752,095 | Jun. 21, 1988 | Brady |
| 5,121,959 | Jun. 16, 1992 | King |

It will be apparent that none of these prior art concepts provides a simple rolling unit adapted for use with a number of different toolbox constructions.

Therefore, a primary objective of this invention is to provide a moveable support system that is easily adapted to truck beds of different shapes and sizes.

A further objective of the present invention is to provide a moveable support system that is easy and economical to manufacture having a minimum of machined parts.

A still further objective of this invention is to provide a moveable support system that is easy to assemble and operate.

A still further objective of this invention is to provide a moveable support system for a crossover box wherein the box cannot be inadvertently removed from the support system.

### SUMMARY OF THE INVENTION

The present invention embodies a pair of channels mounted on the top edges of the sides of a truck body and having a pair of carriage assemblies each having a pair of main support rollers riding on the surface of the channels. The channels are provided with a series of positioning openings and the box assembly includes an anchoring mechanism which is selectively received in the openings to lock the box in the desired longitudinal adjusted position in the channels. Each box includes stabilizing means such as a pair of stabilizing rollers engaging the channels and maintaining the cross alignment of the two carriage assemblies. The construction of the channels and carriage assembly rollers permits the box to not only be adjusted to any desired position along the length of the truck body, but also permits easy removal of the box from the channels to open up the entire load carrying capacity of the body space.

### BRIEF DESCRIPTION OF THE DRAWINGS

FIG. 1 is a perspective view of the channels of this invention.

FIG. 2 is a perspective view showing the carriage assemblies.

FIG. 3 is a perspective view of the follower angle brackets.

FIG. 4 is a perspective view of the stabilizing rollers (casters).

FIG. 5 is a perspective view of the forward angle brackets.

FIG. 6 is a perspective view of the position pins closed.

FIG. 6A is a perspective view of the position pins open.

FIG. 7 is a top plan view of the cross over box of this invention, showing all brackets, casters, position pins, lock, clevis pin, and channels.

FIG. 8 is a cab end view of the channels, carriage assemblies, brackets, casters, lock, and clevis pin mounted on the crossover toolbox, and truck bed sides.

FIG. 9 is an exploded view of the crossover box (end view) and side view of the brackets, position pin, casters, carriage unit, channels, and truck side.

FIG. 10 is a tailgate end view of the crossover box, channels, carriage assemblies, forward brackets, and position pins mounted on a pickup truck side walls.

FIG. 11 is a rear perspective view of this invention mounted on a pickup truck body including a multi drawer lockable toolbox of conventional design bolted to the bottom surface of the crossbox.

### DRAWINGS—REFERENCE NUMERALS

1 Channels 10, 11, 12, 13, 14, 16
2 Carriage Assembly 20, 21, 22, 23, 24, 26 (Waxman Consumer Group, Cleveland, Ohio 44146)
3 Follower Angle Brackets 31, 33, 34, 35
4 Stabilizing Rollers (casters) 41, 42
5 Forward Angle Brackets 53, 54
6 Position Pins 61, 63, 64 (McMaster Carr, Cleveland, Ohio, Catalogue Page 3094, Part # 90222A112)
6A Position Pins 61, 63, 64
15 Truck Body 70
74 Multi Drawer Lockable Toolbox of Conventional Design
17 Conventional Crossbox Toolbox
72 Conventional Padlock
73 Conventional Clevis Pin and Hairpin Clip

### DESCRIPTION OF THE PREFERRED EMBODIMENT

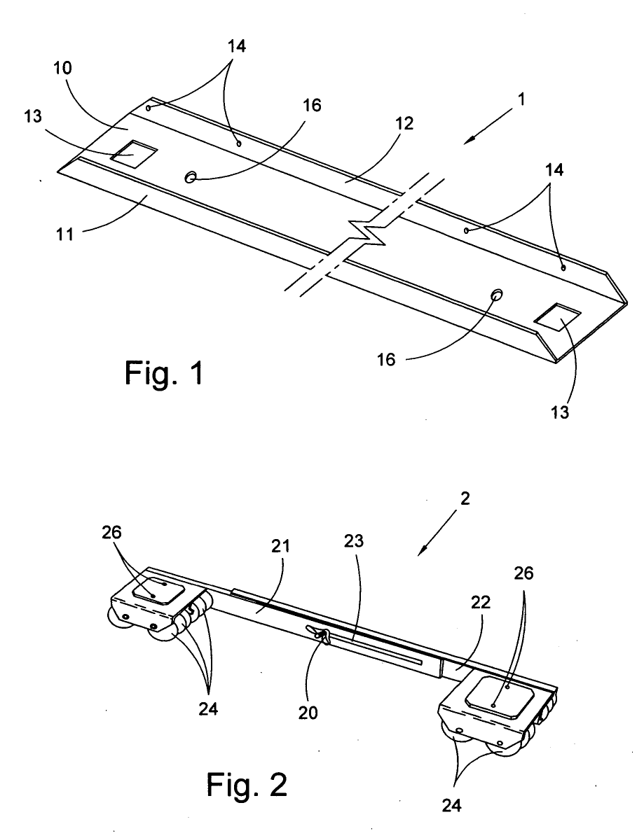

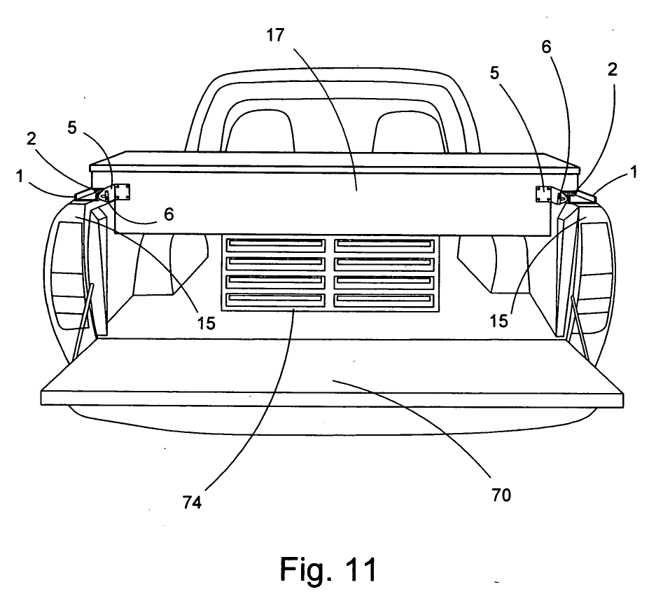

FIG. 11 is a rear perspective view showing the body 15 of a pickup truck with channels 1, FIG. 1 which have provisional mounting holes 16, FIG. 1 providing a means for mounting the channels to the truck body 15 and provisional mounting holes 13, FIG. 1 to accept an overhead ladder rack, if used on the truck body 15. A crossover toolbox 17 with two carriage units 2 attached is sitting in the channels 1. On the front surface of the toolbox 17 are two forward brackets 5 with position pins 6 mounted.

A pair of carriage assemblies 2 are respectively mounted to the bottom of the overhanging ends of the toolbox 17 so that the box is supported on the top of channels 1 surface 10, FIG. 1 and inside the channels 1 vertical flanges 11, 12, FIG. 1.

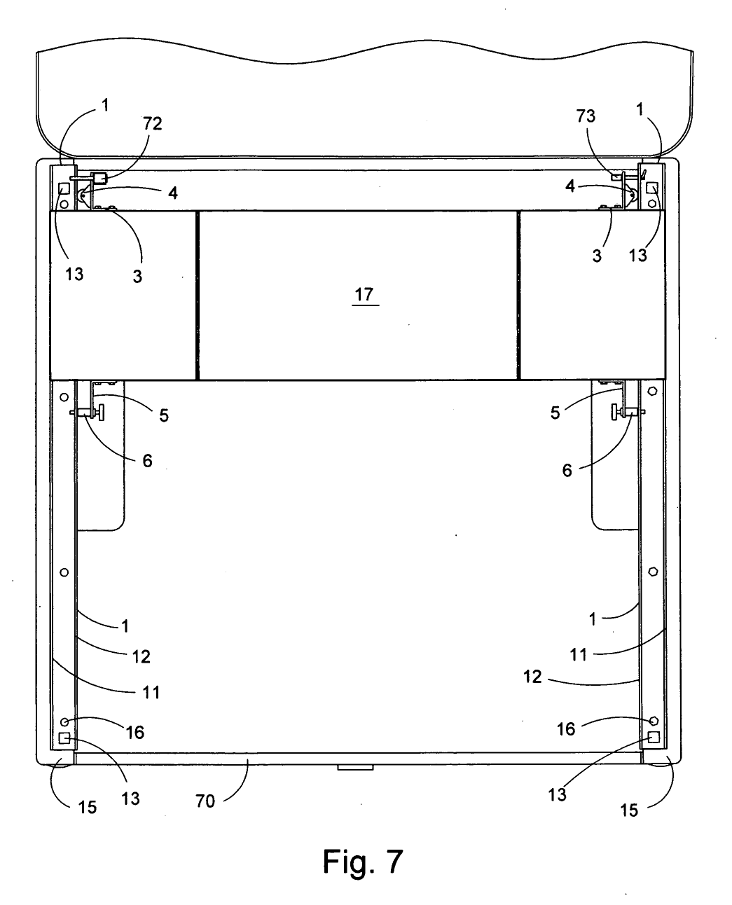

The toolbox 17 is of conventional design as shown in FIGS. 11 and 7 and 8. The toolbox 17 has a pair of laterally extending attachment wings which extend outwardly in overlying relation to the top edge of each side of the truck body 15. Attached to the front surface of the toolbox 17, extending in a longitudinal position and a lateral position of the cross toolbox 17 are two angle brackets 5 mounted using holes, 54, FIG. 5.

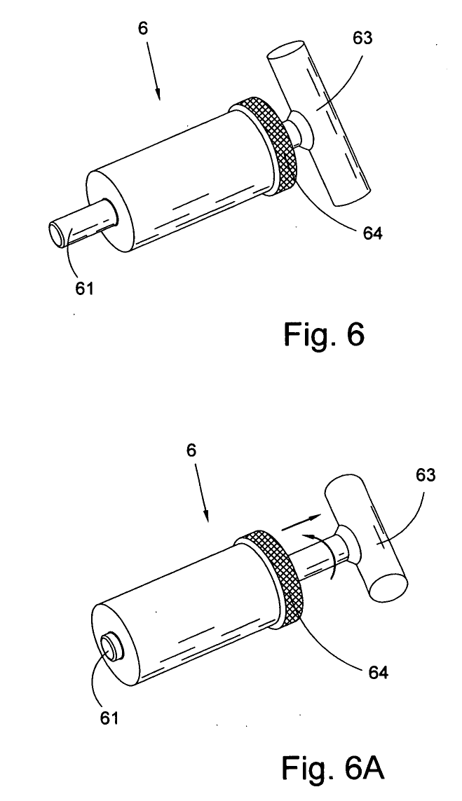

Another device 6 is provided for each angle bracket 5 and each device 6 has a generally T-shaped handle 63, FIG. 6 and a spring loaded locking bolt 61, FIG. 6 (position pin). Each locking pin 6 is fixed to a forward angle bracket 5 through holes 53, FIG. 5 by means of locking nut 64, FIG. 6, 6A and engages the channel 1 vertical flanges 12, FIG. 1 locking holes 14, FIG. 1 to secure the box in the desired position longitudinally on the truck body 15.

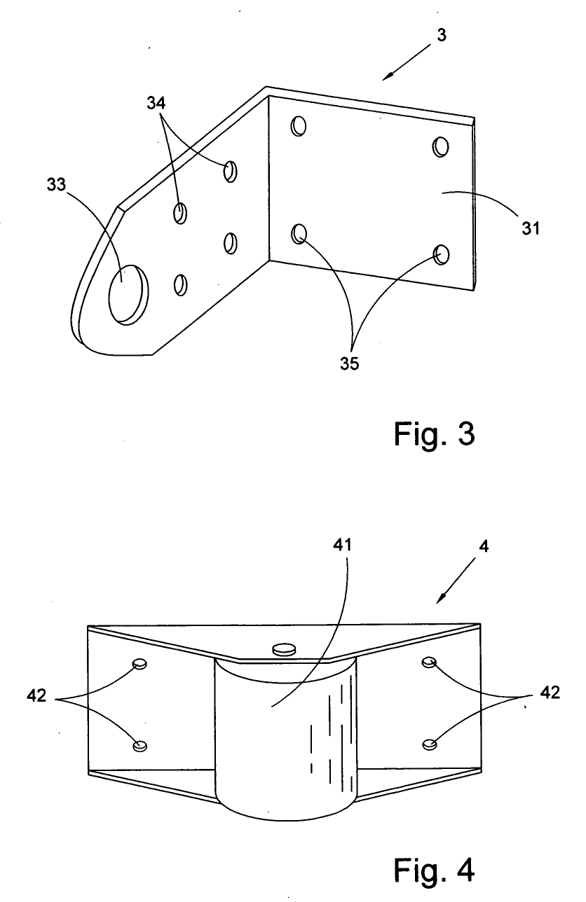

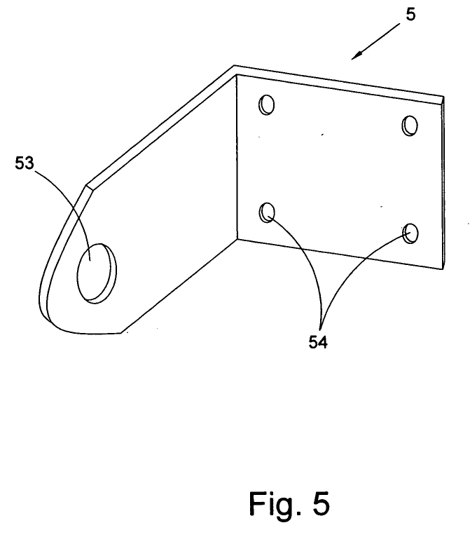

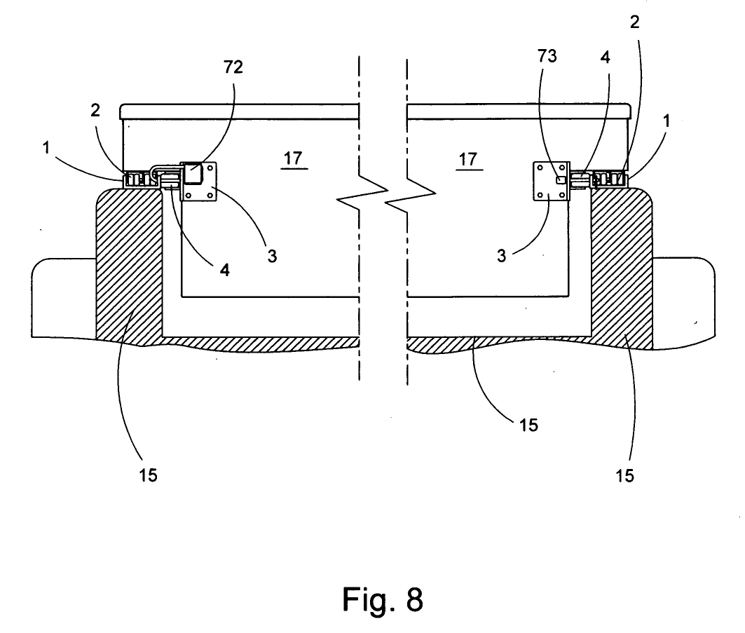

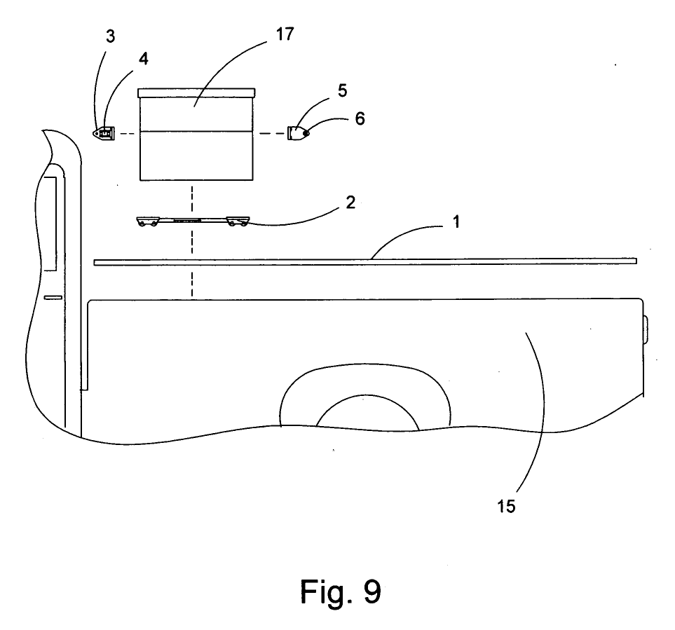

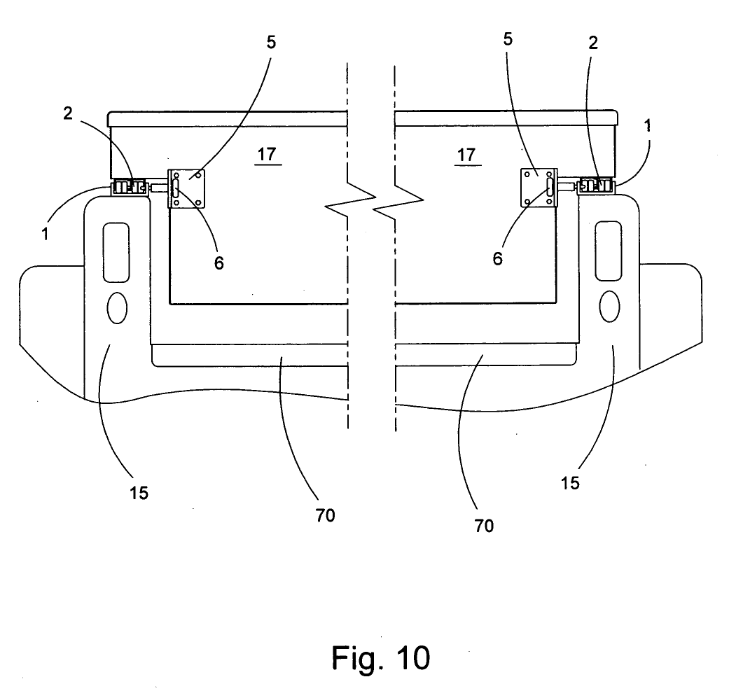

Suitable stabilizing means is provided by a pair of stabilizing rollers 41, FIG. 4 with mounting holes 42, FIG. 4 mounted on follower brackets 3. Each bracket 3 has four suitable mounting holes 34, FIG. 3 provided to permit attachment of each roller 41, FIG. 4 with respect to the adjacent outer surface of the inner vertical flange 12, FIG. 1 of the mounted channels 1. The follower brackets 3 have suitable holes 33, FIG. 3 drilled in the longitudinal section thereby providing a means by which a padlock 72, FIG. 8 of conventional design and a clevis pin and clip 73, FIG. 8 can be inserted through the opposing follower brackets 3 and the longitudinally mounted channels 1 vertical flanges 12, FIG. 1 thereby providing a means of securing the cross toolbox 17 from unauthorized removal or theft thereof. Each follower bracket 3 has holes 35, FIG. 3 drilled into surface 31, FIG. 3 to provide a means of attaching the brackets 3 to the rear surface of cross box 17, FIG. 8.

In another form of the invention shown in FIG. 11 an additional conventional multi drawer lockable toolbox 74, FIG. 1 is mounted to the bottom surface of the cross toolbox 17 providing even easier access to small tools while working at the tailgate 70, FIG. 11.

Because of the design of the channel 1 support system 2, the system can easily be assembled to any pickup truck because the channel 1 roller carriages 2 can be secured to the toolbox at any lateral width through holes 26, FIG. 2 to accommodate the space between the toolbox 17 body and the outer edges of the box 17 overhang. The frame of the carriage assembly 2 can be adjusted lengthwise to accommodate cross boxes 17 of different front to back widths by loosening wing nut 20 and moving frame part 21 along frame part 22 within slot 23 to move frame pads 25 and rollers 24 in or out and then tightening wing nut 20 to lock sliding parts in the correct position before securing the assembly to the bottom surface of the cross box 17 overhang through holes provided 26, FIG. 2. Therefore a consumer can purchase a different pick up truck but still use the same channel 1 support system. Consequently, the present channel 1 support system not only facilitates the easy assembly and use of a mounting support system, but is also economical to manufacture.

It is therefore seen that this invention will achieve at least all of its stated objectives.

I claim:

1. A rollback kit for mounting a toolbox on the top edges of the sides of a pickup truck comprising: a pair of channels having roller engaging portions,
means for positively attaching each of the channels to the upper portions of the respective sides of the pickup truck body to position the roller engaging portions above the respective sides of the truck body entirely outside a cargo carrying space defined between said sides,
a pair of carriage units each having a pair of main rollers spaced apart for engaging top surfaces of the respective channels,
means for positively anchoring each carriage to the toolbox to prevent theft,
means for locking the toolbox to the channels in selected positions longitudinally of the pickup truck, and
stabilizing rollers mounted for engaging said channels to stabilize the movement of the carriages in the channels.

2. The structure set forth in claim 1 wherein the channels have top and side roller engaging surfaces, and wherein said stabilizing rollers engage the side surfaces of the channels, wherein the stabilizing rollers are adjustable toward and away from the channel surfaces which they engage to provide stabilized smooth rolling action in the channels.

3. The structure set forth in claim 1 wherein the locking means includes at least one position pin mounted on the box and releasably interlocking with cooperating portions of the channels.

4. The structure set forth in claim 1 wherein the channels include a plurality of spaced latching holes at predetermined positions along said channels, and wherein the position pins include locking lugs respectively received in selected holes.
